(19) United States
(12) Patent Application Publication
(10) Pub. No.: US 2025/0362578 A1
(43) Pub. Date: Nov. 27, 2025

(54) PROJECTION DISPLAY DEVICE

(71) Applicant: Sharp NEC Display Solutions, Ltd., Tokyo (JP)

(72) Inventor: Yusuke TANI, Tokyo (JP)

(21) Appl. No.: 19/287,164

(22) Filed: Jul. 31, 2025

Related U.S. Application Data
(63) Continuation of application No. PCT/JP2023/006987, filed on Feb. 27, 2023.

(51) Int. Cl. G03B 21/20

(52) U.S. Cl. CPC G03B 21/2086; G03B 21/2033

(57) ABSTRACT

A projection display device includes a light source; and an optical system unit configured to process a light from the light source and to emit the light outside the projection display device. The optical system unit includes an outer shell member having an emission opening positioned at a position from which the light is emitted; and a transparent member disposed at the emission opening of the outer shell member at the emission opening. The transparent member is retained at a retention temperature which is higher by 1° C. or more than an inner-wall temperature of the outer shell member after a light source has been turned off.

### TECHNICAL FIELD

The present disclosure relates to a projection display device.

### BACKGROUND ART

Patent Document 1 discloses a projection display device with an optical system unit in which a transparent member for closing an emission opening formed at a place from which white light is emitted is attached to an outer shell member in which a plurality of optical-system components for appropriately processing light from a light source are accommodated.

### CITATION LIST

### Patent Document

Patent Document 1: WO2011/148498

### SUMMARY OF INVENTION

### Technical Problem

However, fat-and-oil-based organic substances such as sealant or heat-conducting grease used in the outer shell member, a release agent attached at the time of shaping of a metal plate or a die cast in the outer shell member, or fat-and-oil-based organic substances attached at the time of machining become attached to a metal plate or a die cast in the outer shell member, the temperature in the light source is increased with turning-on of a light source, and the fat-and-oil-based organic substances are gasified and floats in the optical system unit. Since the floating gas is liquefied at the time of turning-off of the light source, the floating gas is likely to be attached to the transparent member which is in contact with air outside of the optical system unit and in which the temperature decreases fast. Accordingly, since clouding may occur due to attachment of the floating gas to the transparent member and optical performance of a projector may decrease due to a decrease in transmittance, there is need for curbing attachment of impurities such as fat-and-oil-based organic substances to the transparent member in the optical system unit including the impurities.

The present invention was made in consideration of the aforementioned circumstances, and an objective thereof is to provide a projection display device that can curb attachment of impurities to a transparent member in an optical system unit including impurities and curb a decrease in optical performance.

### Solution to Problem

According to a first aspect of the present invention, there is provided a projection display device including a light source and an optical system unit processing light from the light source and emitting the processed light to the outside, wherein the optical system unit includes an outer shell member, a transparent member is attached to an emission opening provided at a position from which the light is emitted in the outer shell member, and the transparent member is retained at a retention temperature which is higher by 1° C. or more than an inner-wall temperature of the outer shell member after a light source has been turned off.

### Advantageous Effects of Invention

According to the present invention, it is possible to curb attachment of impurities to a transparent member in an optical system unit including impurities and to curb a decrease in optical performance.

### BRIEF DESCRIPTION OF DRAWINGS

FIG. 1 A perspective view illustrating an appearance of a projector according to a first embodiment of the present invention.

FIG. 2 A perspective view illustrating a state in which an upper cover of a housing is detached in the projector illustrated in FIG. 1 when seen from an oblique rear side.

FIG. 3 A perspective view illustrating a light source device in FIG. 2.

FIG. 4 A perspective view illustrating a state in which a glass cover member is disassembled in FIG. 3.

FIG. 5 A horizontal sectional view of the light source device in FIG. 2.

FIG. 6 A partially enlarged view illustrating a state in which the glass cover member is attached in FIG. 5.

FIG. 7 A horizontal sectional view schematically illustrating an outer shell member to which the glass cover member is attached in FIG. 6.

FIG. 8A A sectional view illustrating an operation of an optical system unit and illustrating a state when a light source is not turned on.

FIG. 8B A sectional view illustrating an operation of the optical system unit and illustrating a state when the light source is turned on.

FIG. 8C A sectional view illustrating an operation of the optical system unit and illustrating a state when the light source is turned off.

FIG. 9 A perspective view illustrating an appearance of a light source device according to a second embodiment of the present invention.

FIG. 10 A perspective view illustrating a state in which a glass cover member is disassembled in FIG. 9.

FIG. 11 A partial horizontal sectional view illustrating a state in which the glass cover member is attached in FIG. 9.

FIG. 12 A horizontal sectional view schematically illustrating an outer shell member to which the glass cover member is attached in FIG. 11.

FIG. 13 A horizontal sectional view schematically illustrating an outer shell member in which an adsorbent member is provided according to a third embodiment of the present invention.

FIG. 14 A diagram illustrating measurement results in examples and illustrating a relationship between a post-turning-off elapsed time and a temperature difference.

FIG. 15 A diagram illustrating measurement results in examples and illustrating a relationship between a post-turning-off elapsed time and a temperature difference.

FIG. 16 A diagram illustrating measurement results in examples and illustrating a relationship between a glass thickness and a temperature difference.

### DESCRIPTION OF EMBODIMENTS

### First Embodiment

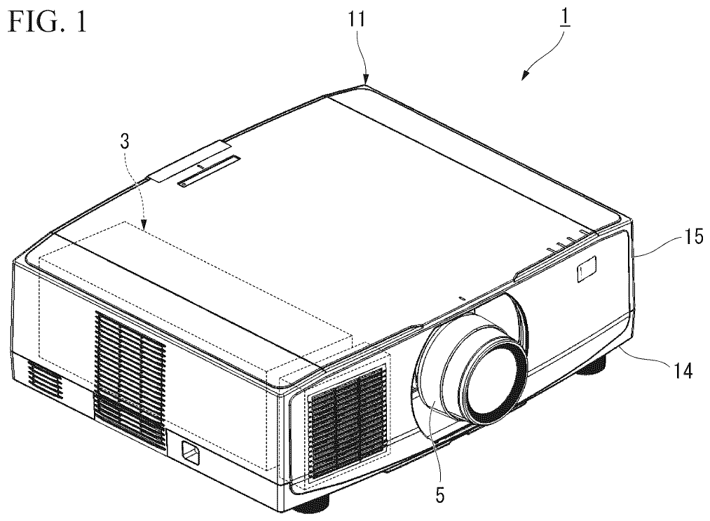

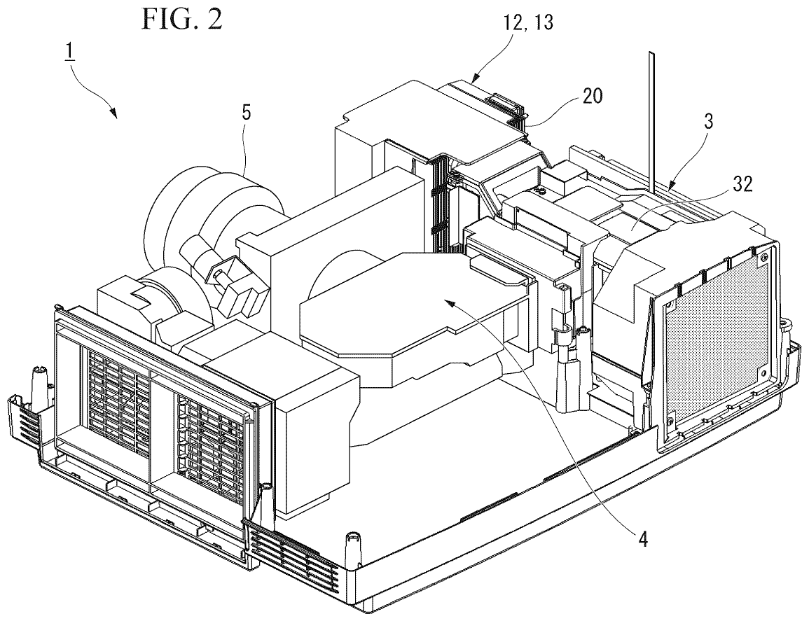

Hereinafter, an embodiment of the present invention will be described with reference to FIGS. 1 to 8.

As illustrated in FIGS. 1 to 3, a projector 1 (a projection display device) according to the present embodiment is a device that projects image light (a video) onto a display plane such as a screen. The projector 1 includes a light source device 3, an image light forming device 4, a projection device 5, a housing 11, an air-blowing fan 12, and a duct 13.

The image light forming device 4 forms image light on the basis of light output from the light source device 3 which will be described later. Although not illustrated, the image light forming device 4 includes an optical modulator such as a digital micromirror device (DMD) or a liquid crystal panel and an electronic component controlling the optical modulator.

The projection device 5 enlarges image light output from the image light forming device 4 and projects the enlarged image light onto a display plane such as a screen.

The housing 11 accommodates the light source device 3, the image light forming device 4, the projection device 5, the air-blowing fan 12, and the duct 13. The housing 11 includes a bottom plate portion 14 on which the light source device 3, the image light forming device 4, the projection device 5, the air-blowing fan 12, and the duct 13 are placed and an upper cover 15 that covers the light source device 3, the image light forming device 4, the projection device 5, the air-blowing fan 12, and the duct 13 from above.

The light source device 3, the air-blowing fan 12, and the duct 13 constitute a cooling structure for cooling a light source 10 of the light source device 3.

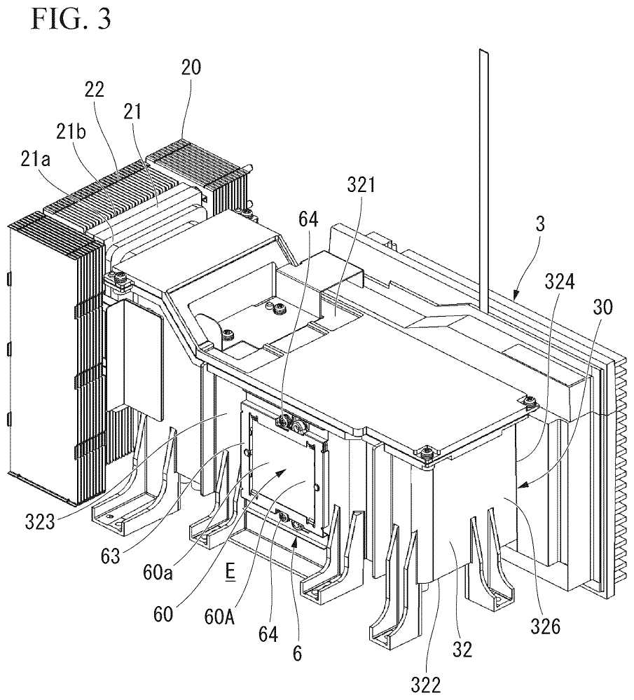

As illustrated in FIGS. 3 to 5, the light source device 3 includes a light source 10, a heat dissipating unit 20, and an optical system unit 30.

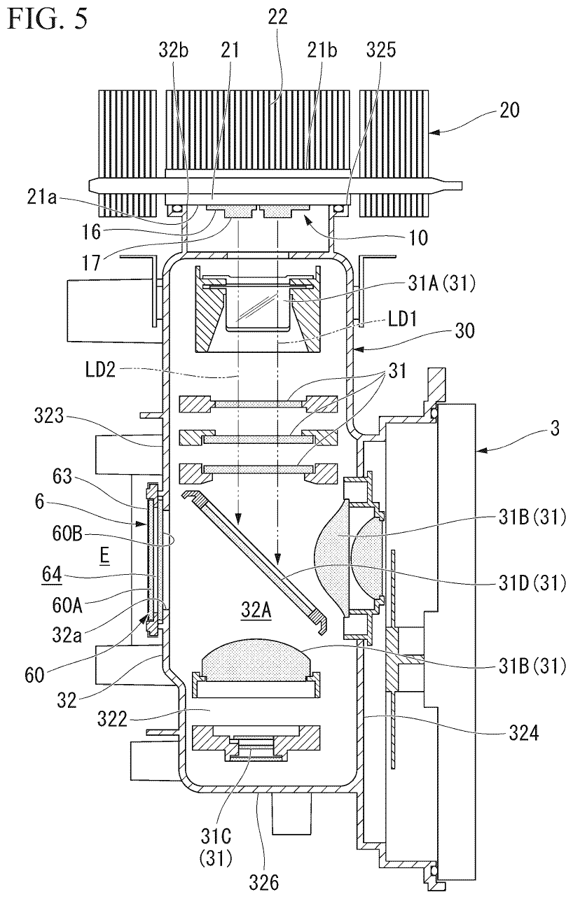

As illustrated in FIG. 5, the light source 10 emits light. In the present embodiment, the light source device 3 includes a plurality of (for example, four) light sources 10. Each light source 10 includes a substrate 16 and a light emitting element 17 mounted on the substrate 16. The light emitting element 17 may be, for example, a light emitting diode (LED) and is a laser diode in the present embodiment. Incidentally, the type of the light emitting element 17 is not particularly limited. The light emitting element 17 in the present embodiment emits laser light in a blue wavelength range. That is, the light source 10 in the present embodiment is a laser substrate. The number of light emitting elements 17 included in the light source 10 is, for example, two but is not limited thereto.

The heat dissipating unit 20 is for cooling the light source 10 and includes a heat dissipating plate 21 and a plurality of heat dissipating fins 22.

The heat dissipating plate 21 is formed in a plate shape including a mount surface 21a and a bottom surface 21b opposite to the mount surface 21a. The mount surface 21a and the bottom surface 21b are formed substantially flat and are substantially parallel to each other.

As illustrated in FIG. 5, the light source 10 is mounted on the mount surface 21a. Specifically, the substrate 16 of the light source 10 is disposed to overlap the mount surface 21a. The substrate 16 may be in direct contact with the mount surface 21a, and transmission of heat from the substrate 16 to the heat dissipating unit 20 is enhanced, for example, by interposing heat-conducting grease which is fat-and-oil-based organic substances between the substrate 16 and the mount surface 21a. The heat dissipating plate 21 is formed of, for example, a conductive material such as copper.

In a state in which the light source 10 is mounted on the mount surface 21a, light generated from the light emitting elements 17 of the light source 10 propagates mainly in a direction away from the mount surface 21a (downward in the drawing surface of FIG. 5). In FIG. 5, arrows LD1 and LD2 indicate a direction in which light emitted from the light source 10 propagates.

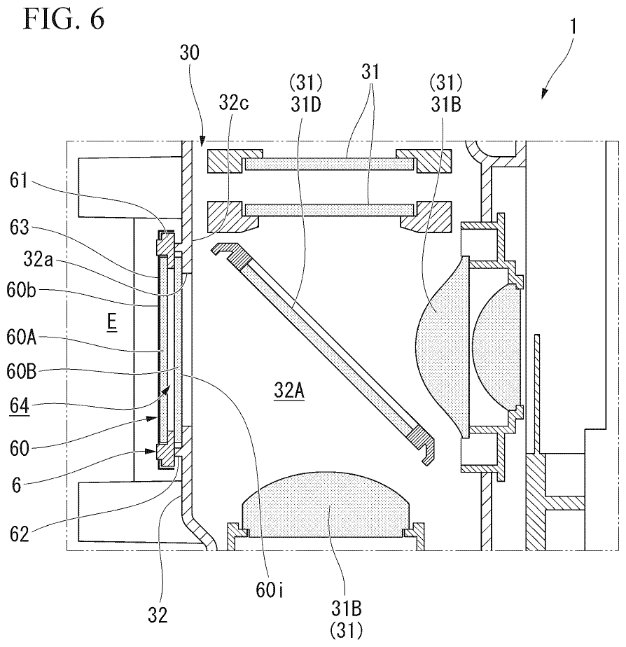

As illustrated in FIGS. 5 and 6, the optical system unit 30 is disposed on the mount surface 21a side of the heat dissipating plate 21 on which the light source 10 is disposed. The optical system unit 30 appropriately processes light (blue light) from the light source 10 and emits white light to the image light forming device 4. The optical system unit 30 includes a plurality of optical system components 31 for appropriately processing light from the light source 10 and an outer shell member 32 for accommodating the optical system components 31.

The optical system components 31 include a reflective mirror 31A, a condensing lens 31B, a diffusion plate 31C, and a dichroic mirror 31D. In FIG. 5, the arrows LD1 and LD2 indicate a direction in which light emitted from the light source 10 propagates. For example, the condensing lens 31B condenses light from the light source 10.

As illustrated in FIGS. 5 to 7, the outer shell member 32 of the optical system unit 30 includes an opening edge for allowing light emitted from the light source 10 to be incident on the inside of the outer shell member 32. The opening edge of the outer shell member 32 comes into close contact with a peripheral area of the mount surface 21a near the light source 10, whereby the light source 10 can be covered by the outer shell member 32. Accordingly, it is possible to curb or prevent dust outside of the outer shell member 32 from reaching the light source 10.

The outer shell member 32 is formed of aluminum by die casting and has a substantially rectangular box shape.

As illustrated in FIGS. 3 to 5, the outer shell member 32 includes a top wall 321, a bottom wall 322, a pair of side walls 323 and 324 extending in a longitudinal direction, a first end wall 325 on the heat dissipating unit 20 side of the pair of side walls 323 and 324, and a second end wall 326 on the opposite side to the heat dissipating unit 20 in the longitudinal direction. An inner space 32A surrounded by the walls (the top wall 321, the bottom wall 322, the side walls 323 and 324, the first end wall 325, and the second end wall 326) of the outer shell member 32 is air-tightly isolated from the outside. Accordingly, as described above, the inner space 32A is protected from the outside air or dust. An outer surface of the outer shell member 32 is provided in contact with air (outside air E).

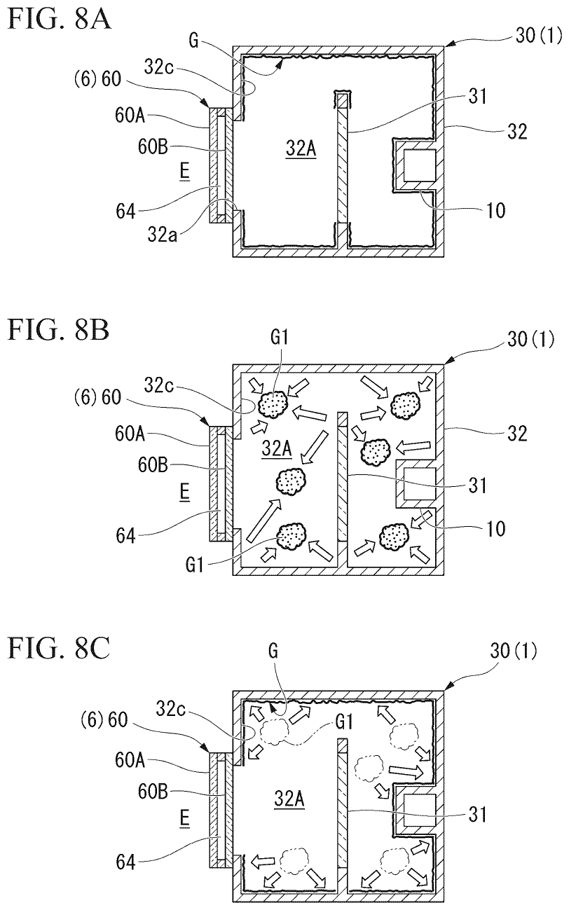

Here, the inner space 32A of the outer shell member 32 includes fat-and-oil-based organic substances (reference sign G in FIG. 8A) which become attached to an inner wall 32c when a light source of the light source 10 is turned off and floats when the light source is turned on. Such fat-and-oil-based organic substances G include impurities such as sealant or heat-conducting grease (conductive grease interposed between the light source 10 and the heat dissipating unit 20) used in the inner space 32A of the outer shell member 32, a release agent attached at the time of shaping of a metal plate or a die cast in the outer shell member, or impurities attached at the time of machining. The fat-and-oil-based organic substances G become attached to a metal plate or a die cast in the outer shell member 32 at a low temperature (for example, lower than 55° C.) and floats in the outer shell member 32 at a high temperature (for example, 55° C. or higher).

In the outer shell member 32, an emission opening 32a is provided at a position from which light is emitted on the side wall 323. The emission opening 32a is formed in a substantially rectangular shape when seen in a direction perpendicular to an opening surface. A glass cover member 6 including a transparent member 60 is attached to the emission opening 32a. Here, the transparent member 60 includes a pair of glass covers 60A and 60B which will be described later and a thermal insulation layer 64 formed between the glass covers 60A and 60B. Specifically, the glass cover member 6 closes the emission opening 32a from the outside of the outer shell member 32 and is provided in a state in which it is in close contact with an opening edge of the emission opening 32a without any clearance.

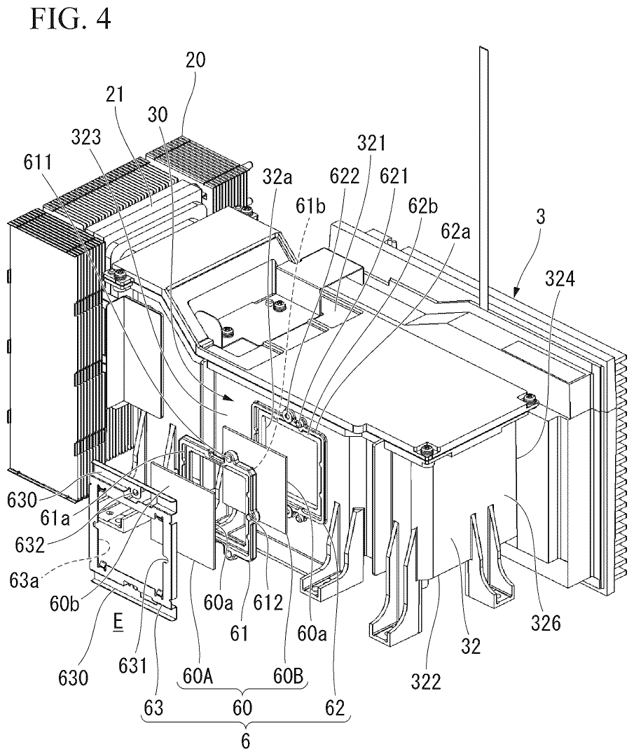

As illustrated in FIGS. 4 to 6, the glass cover member 6 includes a pair of glass covers 60A and 60B (a glass member) with a plate shape disposed with a gap therebetween, a glass holder 61 holding the pair of glass covers 60A and 60B in parallel with a predetermined gap therebetween, a holder frame 62 fixed to a peripheral edge of the emission opening 32a of the outer shell member 32, and a pressing metal sheet 63 pinching and holding the pair of glass covers 60A and 30B with the glass holder 61 interposed along with the holder frame 62.

The transparent member 60 includes an outer glass cover 60A and an inner glass cover 60B. The pair of glass covers 60A and 60B are transparent members having lower thermal conductivity and higher transparency than a member such as a metal plate or an aluminum die cast and are formed in the same shape and the same thickness. The thicknesses of the outer glass cover 60A and the inner glass cover 60B may be different. The pair of glass covers 60A and 60B has a larger rectangular shape than the emission opening 32a in a plan view. The thickness of the pair of glass covers 60A and 60B ranges, for example, from about 1 mm to 2 mm.

As illustrated in FIG. 4, the glass holder 61 is formed in a frame shape and is interposed between the pair of glass covers 60A and 60B. In the glass holder 61, holding recesses 61a and 61b holding other peripheral edges of the glass covers 60A and 60B as a whole are formed on both of the front side and the rear side. The outer peripheral edge 60a of the inner glass cover 60B is held in a second holding recess 61b of the glass holder 61 facing the emission opening 32a. The outer peripheral edge 60a of the outer glass cover 60A is held in a first holding recess 61a of the glass holder 61 facing the opposite side of the emission opening 32a.

By attaching the pair of glass covers 60A and 60B to the glass holder 61, the thermal insulation layer 64 which is surrounded by the pair of glass covers 60A and 60B and the glass holder 61 and in which gas (air) is air-tightly accommodated is formed.

A first engagement hole 611 engaging with the outer shell member 32 and a first engagement protrusion 612 engaging with the pressing metal sheet 63 are provided on an outer peripheral edge of the glass holder 61.

The holder frame 62 is formed in a frame shape with the same size as the glass holder 61. One fixing surface 62a of the holder frame 62 is in liquid-tight contact with the peripheral edge of the emission opening 32a, and a third holding recess 62b holding the outer peripheral edge 60a of the inner glass cover 60B is formed on the other surface. A second engagement convex 621 engaging with the first engagement hole 611 of the glass holder 61 and a second engagement hole 622 engaging with the outer shell member 32 and the pressing metal sheet 63 are provided in the outer peripheral edge of the holder frame 62.

The pressing metal sheet 63 is formed in a frame shape. A fourth holding recess 63a holding the outer peripheral edge 60a of the outer glass cover 60A is formed in a surface of the pressing metal sheet 63 facing the outer shell member 32. A third engagement hole 631 engaging with the first engagement protrusion 612 of the glass holder 61 and a third engagement hole 632 into which a screw 64 illustrated in FIG. 3 and inserted into the second engagement hole 622 of the holder frame 62 is inserted to engage with the outer surface of the outer shell member 32 are provided in the outer circumferential edge of the pressing metal sheet 63. The pressing metal sheet 63 includes a pressing surface 630 on an upper edge and a lower edge. The pressing surface 630 extends along the upper edge and the lower edge and presses the pressing metal sheet 63 on the outer surface of the outer shell member 32 in a state in which the pressing metal sheet 63 is fixed to the outer shell member 32.

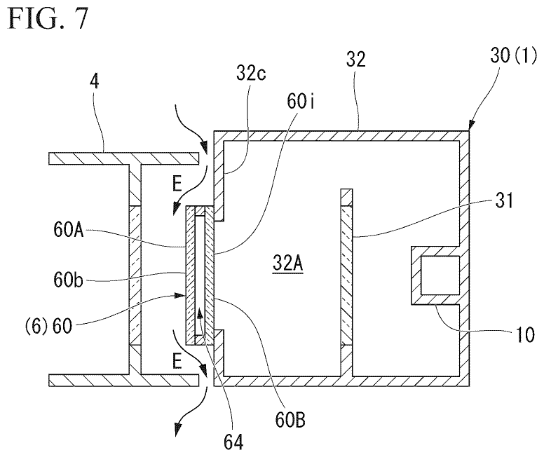

As illustrated in FIGS. 6 and 7, the glass cover member 6 is provided in a state in which a glass outer surface 60b of the outer glass cover 60A is in contact with the outside air E. The transparent member 60 held by the glass cover member 6 in this way is configured such that it is retained at a retention temperature which is higher by 1° C. or more than an inner-wall temperature of the inner wall 32c of the outer shell member 32 after a light source of the light source 10 has been turned off. More specifically, the temperature of the glass inner surface 60i of the inner glass cover 60B (the opposite surface of the outer glass cover 60A) is retained at a temperature which is higher by 1° C. or more than the inner-wall temperature of the inner wall 32c of the outer shell member 32. A retention time of the retention temperature of the glass inner surface 60i of the inner glass cover 60B (a temperature higher by 1° C. or more than the inner-wall temperature of the outer shell member 32 after the light source has been turned off) at that time is 30 minutes or more after the light source has been turned off.

The projector 1 according to the present embodiment includes the light source 10 and the optical system unit 30 processing light from the light source 10 and emitting the light to the outside. The optical system unit 30 includes the outer shell member 32 including fat-and-oil-based organic substances G which are impurities therein. Accordingly, as illustrated in FIG. 8A, when the light source 10 is not turned on, the fat-and-oil-based organic substances G are attached to the inner wall 32c of the outer shell member 32 or a metal plate serving as a structure for holding the optical system components 31 in the outer shell member 32.

When the light source 10 is turned on as illustrated in FIG. 8B, the temperature of the inner space 32A of the outer shell member 32 increases, and the fat-and-oil-based organic substances G attached to the inner wall 32c and the like of the outer shell member 32 is gasified, floats, and becomes floating gas G1. When the light source 10 is turned off as illustrated in FIG. 8C, the temperature of the inner space 32A of the outer shell member 32 decreases, and thus the floating gas G1 is attached to the inner wall 32c and the like of the outer shell member 32 similarly to when the light source is not turned on. At this time, since the outer surface of the outer shell member 32 is in contact with the outside air E, the fat-and-oil-based organic substances G are attached to a part in contact with the outside air E or a part with high thermal conductivity and with a fast decrease in temperature, that is, the inner wall 32c of the outer shell member 32 formed of an aluminum die cast or a metal plate serving as a structure for holding the optical system components 31 after the light source has been turned off. The optical system components 31 such as lenses disposed in the inner space 32A of the outer shell member 32 are not in contact with the outside air E, and the temperature thereof decreases slowly. Accordingly, the floating gas G1 is less likely to be attached to the optical system components 31 again after the light source has been turned off.

In the outer shell member 32 of the projector 1 according to the present embodiment, the transparent member 60 is attached to the emission opening 32a provided at a position from which light is emitted. The transparent member 60 is a glass member, and the glass inner surface 60i of the inner glass cover 60B is retained at the retention temperature higher by 1° C. or more than the inner-wall temperature of the outer shell member 32 after the light source has been turned off.

Accordingly, since the transparent member 60 attached to the emission opening 32a of the outer shell member 32 is retained with a temperature difference of 1° C. or more from the inner-wall temperature of the outer shell member 32 after the light source has been turned off, it is possible to decrease dissipation of heat from the transparent member 60 to the outside air E flowing outside of the outer shell member 32 and to retain the inner-wall temperature of the inner glass cover 60B (the temperature of the glass inner surface 60i) of the transparent member 60 for a predetermined time. As a result, the floating gas G1 floating when the light source is turned on can be actively attached to the parts such as the inner wall 32c of the outer shell member 32 and a metal plate disposed in the inner space 32A of the outer shell member 32, and it is possible to curb attachment of the floating gas to the inner glass cover 60B of the transparent member 60 and to curb a decrease in optical performance.

In the projector 1 according to the present embodiment, the retention time of the temperature of the glass inner surface 60i of the inner glass cover 60B is equal to or more than 30 minutes after the light source has been turned off. In this case, the glass inner surface 60i of the inner glass cover 60B can be retained at the retention temperature higher by 1° C. or more than the inner-wall temperature of the outer shell member 32 for a long time of equal to or more than 30 minutes after the light source has been turned off.

Accordingly, the inner space 32A or the inner wall 32c of the outer shell member 32 reaches the temperature at which the floating gas G1 is liquefied earlier than the transparent member 60, and the floating gas G1 floating when the light source is turned on can be reliably attached to the parts such as the inner wall 32c of the outer shell member 32 and a metal plate provided in the inner space 32A of the outer shell member 32.

In the projector 1 according to the present embodiment, the transparent member 60 includes the pair of glass covers 60A and 60B with a plate shape disposed with a gap therebetween and the thermal insulation layer 64 provided between the pair of glass covers 60A and 60B. Accordingly, a structure with an enhanced heat insulation effect in which the transparent member 60 includes the thermal insulation layer 64 is achieved, and it is possible to effectively decrease dissipation of heat from the transparent member 60 to the outside air E flowing outside of the outer shell member 32 and to retain the inner-wall temperature of the transparent member 60 for a predetermined time. In the present embodiment, the thermal insulation layer 64 is air, but is not limited to air and may be another gas, a solid, or vacuum.

### Second Embodiment

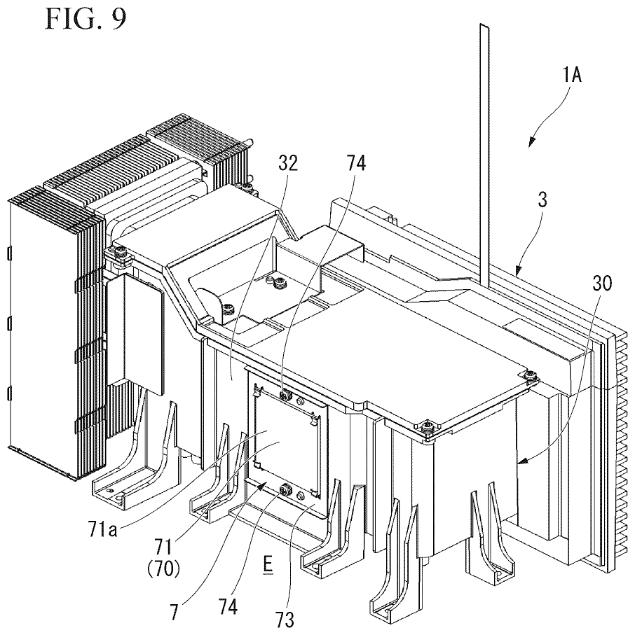

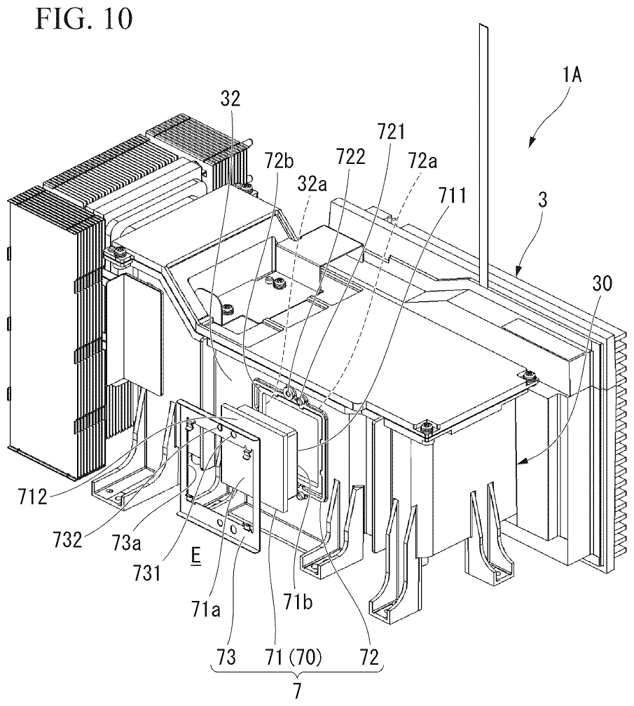

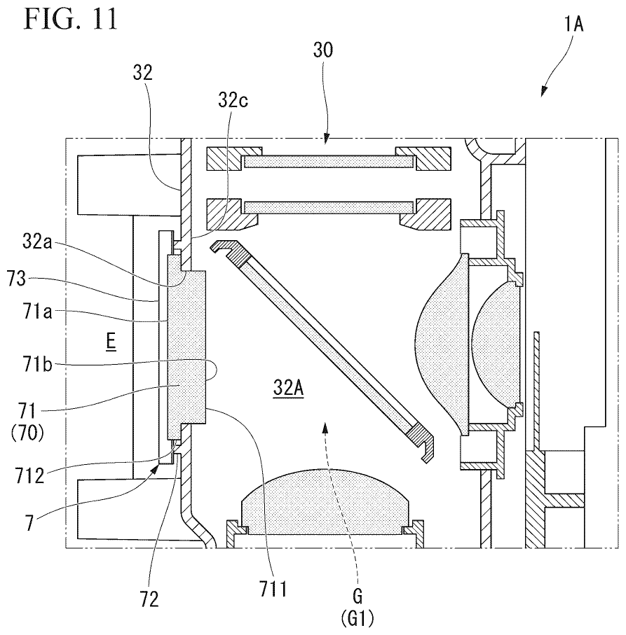

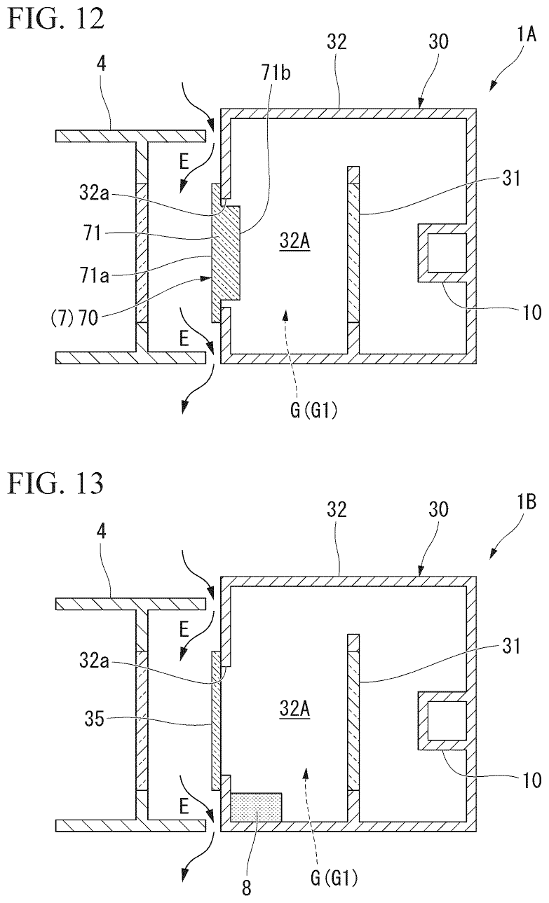

As illustrated in FIGS. 9 to 12, a projector 1A (a projection display device) according to a second embodiment has a configuration in which a glass cover member 7 including a transparent member 70 formed of thick plate glass 71 is attached to an emission opening 32a of an outer shell member 32. That is, the glass cover member 7 is disposed in a state in which it closes the emission opening 32a from the outside of the outer shell member 32 and is closely attached to the peripheral edge of the emission opening 32a without any clearance.

The glass cover member 7 includes thick plate glass 71 (a glass member), a holder frame 72 that is fixed to the peripheral edge of the emission opening 32a of the outer shell member 32, and a pressing metal sheet 73 that interposes and holds the thick plate glass 71 in cooperation with the holder frame 72.

The thick plate glass 71 is a transparent member having lower thermal conductivity and higher transparency than a member such as a metal plate or an aluminum die cast. The thick plate glass 71 is formed like a step including a protruding portion 711 which is convex to one surface. The protruding portion 711 of the thick plate glass 71 forms almost the same rectangular shape as the emission opening 32a in a plan view. The protruding portion 711 is fitted to the inside of the emission opening 32a of the outer shell member 32. That is, the thick plate glass 71 is disposed to be thicker on the inner space 32A side than on the outer surface side of the outer shell member 32. A planar shape of the protruding portion 711 may be smaller than an opening shape of the emission opening 32a. An outer peripheral edge (a flange portion 712) on a glass outer surface 71a side of the thick plate glass 71 is interposed and held between the holder frame 72 and the pressing metal sheet 73.

It is preferable that the thickness of the thick plate glass 71 be equal to or greater than 3 mm in order to retain the retention temperature of the transparent member 70 which will be described later to be higher by 1° C. or more. An upper limit of the thickness of the thick plate glass 71 is, for example, about 10 mm in view of cost.

The holder frame 72 is formed in a frame shape. One fixing surface 72a of the holder frame 72 is in liquid-tight contact with the peripheral edge of the emission opening 32a, and a first holding recess 72b holding the flange portion 712 of the thick plate glass 71 is formed on the other surface thereof. An engagement protrusion 721 engaging with the pressing metal sheet 73 and a first engagement hole 722 engaging with the outer shell member 32 are provided in the outer peripheral edge of the holder frame 72.

The pressing metal sheet 73 is formed in a frame shape. A second holding recess 73a holding the flange portion 712 of the thick plate glass 71 is formed in a surface of the pressing metal sheet 73 facing the outer shell member 32. A second engagement hole 731 engaging with the engagement protrusion 721 of the holder frame 72 and a third engagement hole 732 into which a screw 74 illustrated in FIG. 9 inserted into the first engagement hole 722 of the holder frame 72 is inserted to engage with the outer surface of the outer shell member 32 are provided in the outer circumferential edge of the pressing metal sheet 73.

The glass cover member 7 is provided in a state in which a glass outer surface 71a of the thick plate glass 71 is in contact with the outside air E. The transparent member 70 held by the glass cover member 7 in this way is configured such that it is retained at a retention temperature which is higher by 1° C. or more than the inner-wall temperature of the inner wall 32c of the outer shell member 32 after the light source of the light source 10 has been turned off. More specifically, the temperature of the glass inner surface 71b of the thick plate glass 71 is retained at a temperature which is higher by 1° C. or more than the inner-wall temperature of the inner wall 32c of the outer shell member 32. A retention time of the retention temperature of the glass inner surface 71b of the thick plate glass 71 (a temperature higher by 1° C. or more than the inner-wall temperature of the outer shell member 32 after the light source has been turned off) at that time is 30 minutes or more after the light source has been turned off.

The projector 1A according to the second embodiment has the same operations and advantages as in the first embodiment. That is, since the transparent member 70 attached to the emission opening 32a of the outer shell member 32 is retained with a temperature difference of 1° C. or more from the inner-wall temperature of the outer shell member 32 after the light source has been turned off, it is possible to decrease dissipation of heat from the transparent member 70 to the outside air E flowing outside of the outer shell member 32 and to retain the inner-wall temperature of the transparent member 70 (the temperature of the glass inner surface 71b) for a predetermined time. As a result, the floating gas G1 floating when the light source is turned on can be actively attached to the parts such as the inner wall 32c of the outer shell member 32 and a metal plate disposed in the inner space 32A of the outer shell member 32, and it is possible to curb attachment of the floating gas to the glass inner surface 71b of the transparent member 70 and to curb a decrease in optical performance.

### Third Embodiment

A projector 1B (a projection display device) according to a third embodiment illustrated in FIG. 13 has a configuration in which an adsorbent member 8 that can adsorb fat-and-oil-based organic substances G (impurities) floating in the outer shell member 32 is provided in the inner space 32A. In the third embodiment, a thin plate glass 35 is attached to the emission opening 32a of the outer shell member 32 from the outside of the outer shell member 32. The thin plate glass 35 has, for example, a thickness of about 1 mm to 2 mm and is a glass member having a smaller thickness than those of the transparent members 60 and 70 according to the first embodiment and the second embodiment.

The adsorbent member 8 employs, for example, activated carbon and can adsorb fat-and-oil-based organic substances G. A material that does not gasify once adsorbed fat-and-oil-based organic substances G not to float again can be preferably used as the adsorbent member 8. A position at which the adsorbent member 8 is provided in the inner space 32A of the outer shell member 32 is not particularly limited as long as it is inside of the outer shell member 32 and is preferably near the emission opening 32a.

In the projector 1B according to the third embodiment, since fat-and-oil-based organic substances G (floating gas G1) floating in the inner space 32A of the outer shell member 32 is actively adsorbed on the adsorbent member 8 when the light source has been turned on and when the light source has been turned off, it is possible to decrease an amount of fat-and-oil-based organic substances G floating in the inner space 32A of the outer shell member 32. Accordingly, it is possible to curb attachment of the fat-and-oil-based organic substances G to the thin plate glass 35 and to curb a decrease in optical performance.

By disposing the adsorbent member 8 according to the third embodiment in the outer shell members 32 using the transparent members 60 and 70 according to the first embodiment and the second embodiment, it is possible to achieve the aforementioned effects.

Examples which were performed to verify the advantageous effects of the projection display devices according to the aforementioned embodiments will be described below.

### EXAMPLES

In examples, a temperature difference between the temperature of glass and the inner-wall temperature of the outer shell member based on a difference in glass thickness of the glass cover member was measured using the projector 1 according to the aforementioned embodiment (see FIGS. 1 to 12), and the temperature difference and the heat insulation effect according to the glass thickness were verified.

As shown in Table 1, four cases (Cases 1 to 4) with different conditions such as a glass thickness were employed as test samples. Case 1 is a comparative example in which a thin glass plate with a glass thickness of 1.1 mm was used. Case 2 is an example in which a thick glass plate with a total glass thickness of 4.4 mm in which a convex glass plate with a thickness of 3.3 mm was bonded to a thin glass plate with a glass thickness of 1.1 mm was used and corresponds to the configuration of the second embodiment. Case 3 is an example in which a thick glass plate with a total glass thickness of 7.7 mm in which a convex glass plate with a thickness of 6.6 mm was bonded to a thin glass plate with a glass thickness of 1.1 mm was used and corresponds to the configuration of the second embodiment. Case 4 is an example in which two thin glass plates with a glass thickness of 1.1 mm were disposed with a gap therebetween using spacers and corresponds to the configuration of the first embodiment.

TABLE 1

| | Case 1 | | | Case 2 | | | Case 3 | | | Case 4 | | |
|---|---|---|---|---|---|---|---|---|---|---|---|---|
| | Glass thickness: 1.1 | | | Glass thickness: 4.4 | | | Glass thickness: 7.7 | | | Glass thickness: 1.1 x 2 | | |
| | CG | EG | | CG | EG | | CG | EG | | CG | EG | |
| After | inner | inner | Temperature | inner | inner | Temperature | inner | inner | Temperature | inner | inner | Temperature |
| turning-off | center | wall | difference | center | wall | difference | center | wall | difference | center | wall | difference |
| [min] | [° C.] | [° C.] | [° C.] | [° C.] | [° C.] | [° C.] | [° C.] | [° C.] | [° C.] | [° C.] | [° C.] | [° C.] |
| 0 | 101.5 | 60.0 | 41.5 | 81.2 | 58.7 | 22.5 | 81.9 | 57.6 | 24.3 | 112.0 | 58.9 | 53.1 |
| 1 | 68.9 | 60.5 | 8.4 | 65.9 | 59.4 | 6.5 | 69.6 | 58.6 | 11.0 | 77.2 | 59.0 | 18.2 |
| 2 | 63.8 | 60.5 | 3.3 | 63.7 | 59.7 | 4.0 | 66.6 | 57.7 | 8.9 | 68.7 | 58.7 | 10.0 |
| 3 | 61.9 | 60.3 | 1.6 | 62.4 | 59.3 | 3.1 | 65.0 | 57.3 | 7.7 | 64.5 | 58.8 | 5.7 |
| 4 | 60.6 | 59.6 | 1.0 | 61.6 | 58.7 | 2.9 | 64.6 | 58.1 | 6.5 | 62.8 | 58.0 | 4.8 |
| 5 | 59.5 | 59.0 | 0.5 | 60.4 | 57.9 | 2.5 | 63.6 | 57.5 | 6.1 | 60.9 | 57.6 | 3.3 |
| 10 | 55.8 | 55.4 | 0.4 | 56.6 | 54.3 | 2.3 | 58.9 | 54.2 | 4.7 | 56.6 | 54.4 | 2.2 |
| 20 | 50.3 | 50.0 | 0.3 | 50.7 | 48.9 | 1.8 | 52.6 | 49.2 | 3.4 | 50.7 | 49.0 | 1.7 |
| 30 | 46.0 | 45.8 | 0.3 | 46.3 | 44.8 | 1.5 | 47.8 | 45.3 | 2.5 | 46.9 | 45.3 | 1.6 |

In each of Cases 1 to 4, a center temperature (C) inside of glass (CG) (on the outer shell member side) and the inner-wall temperature (° C.) of the outer shell member (EG) were measured every elapsed time (turning-off (0 minutes), 1 minute, 2 minutes, 3 minutes, 4 minutes, 5 minutes, 10 minutes, 20 minutes, and 30 minutes) after the light source was turned off, and a time difference (° C.) therebetween was calculated. Since the center temperature in the glass was higher than the inner-wall temperature of the outer shell member, the temperature difference indicates how the temperature of the center of the glass is higher than that of the inner wall of the outer shell member. In Cases 1 to 4, it was evaluated whether the temperature difference was secured to be 1° C. or higher in 30 minutes and 5 minutes after the light source has been turned off. The temperature difference 1° C. or more serving as an evaluation criterion is based on the thought that impurities (fat-and-oil-based organic substances) are attached to the inner wall of the outer shell member at a lower temperature when there is a temperature difference of 1° C. or more.

In Cases 1 to 4, a state in which impurities (fat-and-oil-based organic substances) are attached to glass surface was visually checked.

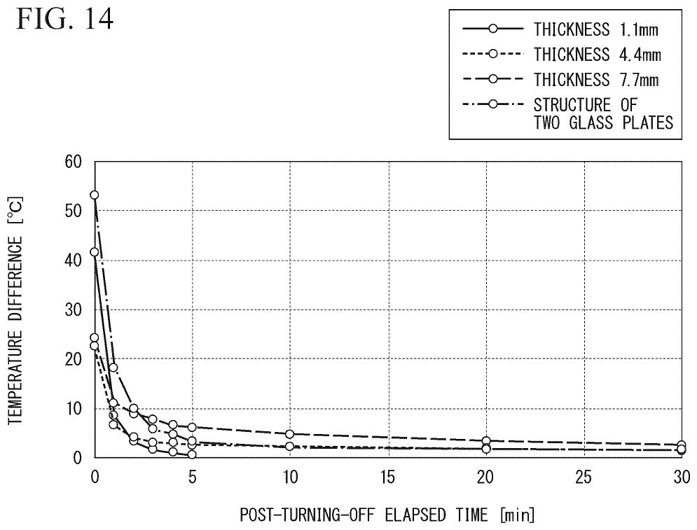

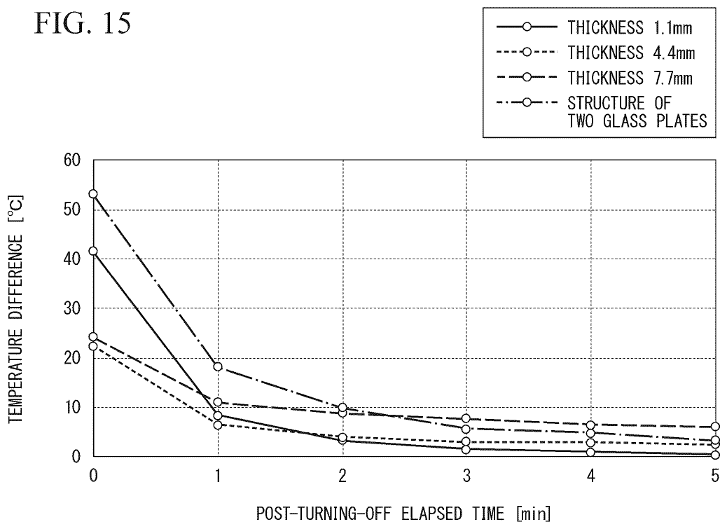

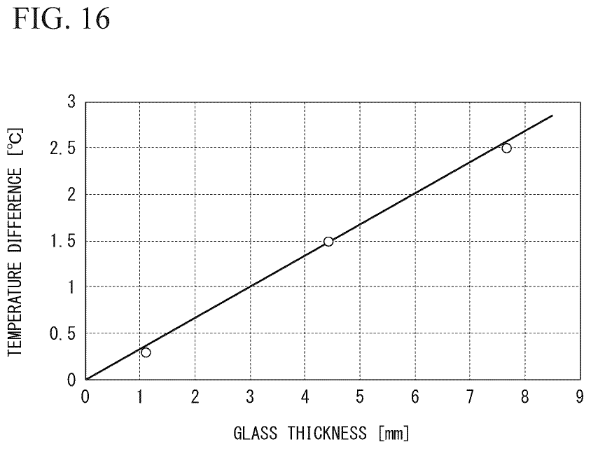

FIGS. 14 to 16 illustrate measurement results according to the examples. FIGS. 14 and 15 are graphs of Cases 1 to 4 in which the horizontal axis represents the post-turning-off elapsed time (minutes) and the vertical axis represents the temperature difference (° C.). FIG. 14 is a diagram illustrating the post-turning-off elapsed time until 30 minutes. FIG. 15 is a diagram illustrating the post-turning-off elapsed time until 5 minutes. FIG. 16 is a graph illustrating measurement results of Cases 1 to 3 when the post-turning-off elapsed time is 30 minutes or more where the horizontal axis represents the glass thickness (mm) and the vertical axis represents the temperature difference (° C.).

As illustrated in Table 1 and FIGS. 14 and 15, the temperature difference in Cases 1 to 4 decreases with the post-turning-off elapsed time. In Case 1, it was seen that the temperature difference of 1° C. or more was secured until the elapsed time reaches 4 minutes after the light source had been turned off and became 0.5° C. after the elapsed time had exceeded 5 minutes, and the temperature difference between the inner center of glass and the inner-wall temperature of the outer shell member becomes less than 1° C. In Case 1, it was seen that fat-and-oil-based organic substances were attached to the glass surface.

On the other hand, in Cases 2, 3, and 4, it was seen that the temperature difference of 1° C. or more could be sufficiently secured even when the measured maximum elapsed time is 30 minutes after the light source had been turned off and the temperature difference was equal to or greater than 2° C. even in 5 minutes after the light source has been turned off. As in Cases 2 and 3, as the thickness of the thick glass plate increases, the temperature difference increases even in the same time after the light source has been turned off. In Case 4, the temperature difference can be set to be greater than that of the thick glass plate of 4.4 mm in Case 2. In Cases 2, 3, and 4, attachment of fat-and-oil-based organic substances to the glass surface was not visually ascertained.

It was seen in FIG. 16 that the temperature differences increase in proportion to the glass thickness. Accordingly, it was seen that the temperature difference of 1° C. or more could be secured by setting the glass thickness to 3 mm or more.

While embodiments of the present invention have been described above, the present invention is not limited to the embodiments and can be appropriately modified without departing from the gist thereof.

The present invention employs a configuration in which the retention time of the retention temperature of the transparent member is set such that 1° C. or more is secured until 30 minutes or more after the light source has been turned off, but the retention time is not limited to 30 minutes or more.

The transparent member attached to the emission opening of the outer shell member employs a configuration in which the thermal insulation layer 64 is provided between a pair of glass covers 60A and 60B in the first embodiment and employs a configuration in which the thick glass plate 71 is provided in the second embodiment, but the present invention is not limited to the transparent members 60 and 70 in the configurations and may employ a transparent member with a different shape and form.

In the second embodiment, the protruding portion 711 of the thick plate glass 71 with a stepped form is provided to be fitted into the emission opening 32a of the outer shell member 32 and to have a thickness on the inner space 32A side with respect to the outer surface of the outer shell member 32, but the present invention is not limited to the thick glass plate of such a shape. For example, a thick glass plate with a constant thickness over the whole surface may be disposed to only the outside of the outer shell member 32.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1, 1A, 1B Projector (projection display device)
3 Light source device
6, 7 Glass cover member
10 Light source
20 Heat dissipating unit
30 Optical system unit
31 Optical system component
32 Outer shell member
32A Inner space
32a Emission opening
60, 70 Transparent member
60A Outer glass cover (glass member)
60B Inner glass cover (glass member)
61 Glass holder
62, 72 Holding frame
63, 73 Pressing metal sheet
64 Thermal insulation layer
71 Thick plate glass
E Outside air
G Fat-and-oil-based organic substance (impurity)

What is claimed is:

1. A projection display device comprising:
a light source; and
an optical system unit configured to process a light from the light source and to emit the light outside the projection display device,
wherein the optical system unit comprises:
an outer shell member having an emission opening positioned at a position from which the light is emitted; and
a transparent member disposed at the emission opening of the outer shell member at the emission opening, and
wherein the transparent member is retained at a retention temperature which is higher by 1° C. or more than an inner-wall temperature of the outer shell member after a light source has been turned off.

2. The projection display device according to claim 1, wherein a retention time of the retention temperature of the transparent member is 30 minutes or more after the light source has been turned off.

3. The projection display device according to claim 1, wherein the transparent member comprises:
a pair of glass members which are plate-shaped and disposed with a gap between the pair of glass members; and
a thermal insulation layer disposed between the pair of glass members.

4. The projection display device according to claim 1, wherein the transparent member comprise a thick plate glass.

5. The projection display device according to claim 4, wherein the thick plate glass has a thickness which is equal to or greater than 3 mm.

6. The projection display device according to claim 4, wherein the thick plate glass has a thickness on an inner space side with respect to an outer surface of the outer shell member.

7. The projection display device according to claim 1, wherein the light source comprises a laser diode.

8. A projection display device comprising:
a light source; and
an optical system unit configured to process a light from the light source and to emit the light outside the projection display device,
wherein the optical system unit comprises:
an outer shell member having an emission opening positioned at a position from which the light is emitted; and
a transparent member disposed at the emission opening of the outer shell member at the emission opening, and
wherein the transparent member comprises:
a pair of glass members which are plate-shaped and disposed with a gap between the pair of glass members; and
an air disposed between the pair of glass members.
